(19) United States
(12) Patent Application Publication
(10) Pub. No.: US 2026/0305726 A1
(43) Pub. Date: Oct. 8, 2026

(54) A Cleaning Tool for Cleaning an Aerosol Generating Device and an Aerosol Generating System Comprising a Cleaning Tool

(71) Applicant: JT International SA, Geneva (CH)

(72) Inventors: Jaakko McEvoy, Vienna (AT); Alec Wright, Guildford (GB)

(73) Assignee: JT International SA, Geneva (CH)

(21) Appl. No.: 19/481,280

(22) PCT Filed: May 10, 2024
(86) PCT No.: PCT/EP2024/062945

§ 371 Date: Nov. 4, 2025

(30) Foreign Application Priority Data
May 12, 2023 (EP) 23173007.8

(51) Int. Cl. A24F 40/85; A24F 40/20; A24F 40/57; B08B 9/00

(52) U.S. Cl. CPC A24F 40/85; A24F 40/20; A24F 40/57; B08B 9/00

(57) ABSTRACT

A cleaning tool for cleaning an aerosol generating device having a receiving cavity configured to receive a tobacco article and a heater configured to heat the receiving cavity, the cleaning tool extending along a tool axis and including a flat-shaped cleaning portion configured to be inserted in the receiving cavity and including a core forming at least two opposite surfaces, and at least one layer arranged adjacent to one of the opposite surfaces of the core and formed from a first absorptive material to absorb humidity inside the receiving cavity.

### FIELD OF THE INVENTION

The present invention concerns a cleaning tool for cleaning an aerosol generating device.

The invention also concerns an aerosol generating system comprising an aerosol generating device comprising a receiving cavity configured to receive a tobacco article and a heater configured to heat the receiving cavity, and further comprising a cleaning tool.

The tobacco article comprises for example a solid substrate able to form aerosol when being heated. Thus, such type of aerosol generating device, also known as heat-not-burn system or heat-not-burn device, is adapted to heat, rather than burn, the substrate by conduction, convection and/or radiation, to generate aerosol for inhalation.

### BACKGROUND OF THE INVENTION

The popularity and use of reduced-risk or modified-risk aerosol generating systems (also known as vaporisers) has grown rapidly in the past few years as an aid to assist habitual smokers wishing to quit smoking traditional tobacco products such as cigarettes, cigars, cigarillos, and rolling tobacco. Various devices and systems are available that heat or warm vaporizable substances as opposed to burning tobacco in conventional tobacco products.

A commonly available reduced-risk or modified-risk system is the heated substrate aerosol generation system or heat-not-burn device. Systems of this type generate aerosol or vapour by heating an aerosol substrate that typically comprises moist leaf tobacco or other suitable vaporizable material to a temperature typically in the range 150 °C to 350 °C. Heating an aerosol substrate, but not combusting or burning it, releases aerosol that comprises the components sought by the user but not the toxic and carcinogenic by-products of combustion and burning. Furthermore, the aerosol produced by heating the tobacco or other vaporizable material does not typically comprise the burnt or bitter taste resulting from combustion and burning that can be unpleasant for the user and so the substrate does not therefore require the sugars and other additives that are typically added to such materials to make the smoke and/or vapour more palatable for the user.

Such aerosol generating systems generate thus aerosol during heating by a heater. However, a user may draw only during some moments and pause between puffs. During such pauses between puffs, in some cases, some aerosol may be generated without being inhaled by the user, and leak for example to the outside of the system, or aggregate as a condensate of aerosol in peripheral cavities of the system. This may be in particular the case if high volumes of vapour are generated. In some cases, condensate may be formed in hard to reach places inside the device. Such condensate may require thus additional cleaning of the system in some cases. Furthermore, in some examples, dirt may enter the system from outside and may lead to a reduced quality of aerosol, thus downgrading user experience.

### SUMMARY OF THE INVENTION

One of the aims of the invention is to provide a cleaning tool for cleaning an aerosol generating device that adapted to be handled easily by a user and provides effective cleaning.

For this purpose, the invention relates to a cleaning tool for cleaning an aerosol generating device, the aerosol generating device comprising a receiving cavity configured to receive a tobacco article, and a heater configured to heat the receiving cavity;
the cleaning tool extending along a tool axis and comprising a flat-shaped cleaning portion configured to be inserted in the receiving cavity and comprising:
a core forming at least two opposite surfaces;
at least one layer arranged adjacent to one of the opposite surfaces of the core and formed from a first absorptive material to absorb humidity inside the receiving cavity.

Thanks to these features, the cleaning tool allows cleaning the aerosol generating device in an effective manner, and is handled easily by the user. Indeed, the cleaning tool allows efficient cleaning thanks to the cleaning portion comprising the core and at least one layer formed from an absorptive material, that is a cleaning portion having different components or layers.

Further, since the cleaning portion is flat-shaped, the cleaning portion may present a large surface for cleaning and/or absorbing humidity.

For example, the cleaning tool may present a shape substantially identical to the tobacco article configured to be received in the receiving cavity upon use of the aerosol generating device by generating aerosol, such as a substantially identical length, height and/or width and/or an identical geometrical form.

According to some examples, the cleaning portion may present a rectangular shape. For example, the cleaning portion may present the following dimensions: a width comprised between 11 mm and 18 mm; a height comprised between 1.2 mm and 2 mm, and a length comprised between 25 mm and 50 mm. According to examples, the receiving cavity presents a height smaller than 2 mm.

According to an example, the core may be made from a different material than the first absorptive material. For example, the material of the core may be more rigid than the first absorptive material of the layer(s) arranged adjacent to the opposite surfaces of the core. For example, the core may provide mechanical stability to the cleaning tool and the layer(s) of the first absorptive material may be particularly adapted for cleaning and absorbing humidity. According to some examples, the material of the core allows cleaning and/or absorbing humidity. For example, the material of the core is adapted to absorb a different quantity of humidity per volume of the core than the first absorptive material. According to some examples, the first absorptive material may form a coating of the cleaning portion.

The cleaning tool can be handled easily by the user, because the cleaning portion is configured to be inserted in the receiving cavity. This allows quick and easy cleaning, even for example in cases according to which the receiving cavity can be accessed from one side only. According to some examples, the cleaning portion may present a complementary form and/or complementary shape to a form/shape of the receiving cavity. That is, for example, the form/shape of the cleaning portion may be adapted to the form/shape of the receiving cavity. For example, if the receiving cavity presents a flat shape or rectangular shape, the cleaning tool may also present a flat shape or rectangular shape. According to some other examples, the cleaning portion configured to be inserted in the receiving cavity presents a shape that is different from a shape of the receiving cavity. For example, in this case, the cleaning portion may present a round, e.g. circular, cross section, whereas the receiving cavity may present a rectangular cross section. Such cross-sections may be defined according to a plane perpendicular to the tool axis and/or the device axis. The cleaning portion, and in particular at least the layer formed from the first absorptive material, may be configured to be compressed upon insertion of the cleaning tool into the receiving cavity.

In some embodiments, the cleaning portion comprises a sheath comprising said first absorptive material, the sheath covering at least partially the core.

Thanks to these features, the core of the cleaning portion is protected at least partially by the sheath. The sheath may for example be configured to adapt to different shapes of the receiving cavity. This allows in particular flexible and efficient cleaning, thanks to an adaptation of the corresponding shape of the receiving cavity.

Furthermore, the sheath presents a simple structure, and allows thus to manufacture the cleaning tool in an easy and quick manner. For example, the sheath may present a shape of a wrapper. For example, the sheath may form at least one sheet, preferable one single sheet, that is bended so as to cover at least partially the core.

According to some examples, the sheath may completely cover the core. This allows in particular very efficient cleaning as a large surface of the sheath may enter in contact with the humidity inside the receiving cavity. For example, the sheath may cover a complete circumference of the core. The sheath is thus in particular adapted to absorb humidity between the core and walls of the receiving cavity when the cleaning tool is inserted into the aerosol generating device.

According to some examples, the sheath may comprise or consist of blotting paper, a cotton material or super absorbent fiber, also called SAF. For example, the sheath may be heat resistant up to 200 °C.

In some embodiments, the core forms a rigid structure.

Thanks to these features, the cleaning tool presents a high mechanical stability. Thus, cleaning is facilitated for a user.

In some embodiments, the core comprises a second absorptive material able to absorb humidity.

Thanks to these features, a high amount of humidity may be absorbed by the cleaning tool. In particular, both the first and the second absorptive material may absorb humidity inside the receiving cavity. By “first absorptive material” and “second absorptive material”, it is in particular understood that the first absorptive material presents a different material type and/or different composition of materials compared with the second absorptive material. This allows for example absorbing efficiently droplets of humidity having a different viscosity.

In some embodiments, the core comprises a plurality of fibers.

Thanks to these features, the absorption of humidity may be implemented at least partially by the plurality of fibers and allow efficient cleaning.

According to examples, an overall length of the cleaning tool and/or of the fibers is greater than a length of the receiving cavity defined between a bottom wall of the receiving cavity and an insertion opening. The insertion opening is in particular configured to receive the cleaning tool and/or to receive a mouthpiece upon use of the aerosol generating device by a user. For example, the cleaning tool may be adapted to be depressed in the receiving cavity and thanks to the overall length of the cleaning tool and/or of the fibers, the fibers enter in contact with the bottom wall for cleaning. According to examples, the fibers may have a length of between 2 mm to 10 mm.

In some embodiments, the fibers are oriented according to the tool axis.

Thanks to these features, cleaning is improved.

For example, respective ends of the fibers may be arranged so as to enter in contact with an end of the receiving cavity. These features allow in particular absorbing a large quantity of humidity and/or dirt by the ends of the fibers. For example, the fibers are oriented so as to extend perpendicular to a bottom wall of the receiving cavity when the cleaning tool is inserted into the receiving cavity.

According to an example, the fibers may present spaces between each other that are arranged so as to receive additional humidity and/or dirt from the receiving cavity.

In some embodiments, the cleaning portion comprises a sheath, wherein the fibers are mounted on a plunger movable according to the tool axis in respect with the sheath.

According to examples, the fibers may be glued, bonded, clamped, or molded to the plunger.

Thanks to these features, the fibers are arranged to extend from the sheath towards the receiving cavity when the plunger is moved with respect with the sheath. In other words, in particular, these features allow sliding the fibers relatively to the sheath. This allows improving cleaning and/or absorbing humidity in the receiving cavity by the cleaning tool, and in particular in an end portion of the receiving cavity. In particular, thanks to this relative movement, first a user may insert the cleaning portion with the sheath and the fibers, and then activate the plunger so as to extend the fibers further forward into the receiving cavity for cleaning and/or absorbing humidity.

In some embodiments, upon activating the plunger, the fibers are configured to extend from a distal end of the cleaning tool configured to face a bottom wall of the receiving cavity.

Thanks to these features, the cleaning tool allows very efficient cleaning of the bottom wall of the receiving cavity, in particular at a distal end of the receiving cavity. In particular, the fibers may form a brush facing or contacting the bottom wall of the receiving cavity. In particular, the ends of the fibers may be arranged to absorb humidity adjacent to the bottom wall.

In some embodiments, upon activating the plunger, the fibers are configured to pierce the sheath.

Thanks to these features, before insertion and during an insertion movement of the cleaning tool into the receiving cavity, the fibers are protected by the sheath. This allows ensuring that the fibers remain in parallel to the tool axis before insertion and during the insertion movement into the cavity. For example when the cleaning tool is completely inserted into the receiving cavity, the fibers may pierce the sheath, in particular by a relative movement between the fibers and the sheath. Thus, upon complete insertion, the ends of the fibers allow cleaning in particular the bottom wall of the receiving cavity, and may further for example adapt/adjust to a form of the bottom wall. This also allows cleaning areas of the receiving cavity that are hard to reach.

In some embodiments, the cleaning tool further comprises a gripping portion arranged successively with the cleaning portion and designed to be outside the receiving cavity when the cleaning portion is inserted in the receiving cavity.

Thanks to these features, the cleaning tool with the fibers can be inserted easily by a user.

In some embodiments, the gripping portion is designed to be inserted into a central hole of a mouthpiece and/or comprises a plunger movable according to the tool axis.

Thanks to these features, cleaning the receiving cavity is very easy for the user. When the gripping portion is designed to be inserted into a central hole of a mouthpiece, the user may first insert the gripping portion into the central hole, and then place the mouthpiece on the insertion opening of the receiving cavity so that the cleaning tool is received in the cavity. When the gripping portion comprises the plunger, this may allow pushing the fibers further into the cavity when actuating the plunger, and thus improve cleaning.

In some embodiments, the or each absorptive material is chosen in the group comprising:
cotton;
absorbent paper such as blotting paper;
super absorbent fiber;
porous material such porous polymeric fiber or porous composite;
functionalized or bioactivated porous media.

Thanks to these features, the or each absorptive material allows absorbing a high and/or predetermined quantity of humidity.

The invention further relates to an aerosol generating system comprising:
an aerosol generating device comprising a receiving cavity configured to receive a tobacco article and a heater configured to heat the receiving cavity;
a cleaning tool as described above, the cleaning portion of said cleaning tool being configured to be inserted in the receiving cavity of said aerosol generating device.

In some embodiments, the aerosol generating device comprises a controller configured to control the heater according to a cleaning heating profile for using with the cleaning tool, the cleaning heating profile being different from a heating profile used to generate aerosol from a tobacco article.

Thanks to these features, the humidity and/or condensate inside the receiving cavity may be vaporized/evaporated and reduction in viscosity of the humidity and/or condensate inside the receiving cavity may be obtained. Thus, the cleaning tool can then absorb the humidity more readily. For example, the cleaning heating profile may control the temperature inside the receiving cavity for a temperature equal to or lower than 200 °C. According to some examples, the cleaning heating profile may control the temperature inside the receiving cavity for a temperature strictly lower than 200 °C, preferably strictly lower than 180 °C.

### BRIEF DESCRIPTION OF THE DRAWINGS

The disclosure and its advantages will be better understood upon reading the following description, which is given by way of non-limiting example and which is made with reference to the appended drawings, in which:

FIG. 1 is a perspective view of an aerosol generating system comprising an aerosol generating device and a tobacco article, the tobacco article being usable with the aerosol generating device;

FIG. 2 is a perspective view of the tobacco article of FIG. 1, the tobacco article comprising a wrapper;

FIG. 3 is a perspective view of a cleaning tool according to a first embodiment of the invention for cleaning the aerosol generating device of FIG. 1, wherein the cleaning tool is in a retracted state;

FIG. 4 is a perspective view similar to the view of FIG. 3 of the cleaning tool in an extended state;

FIG. 5 is a perspective view with a partial cross-section of the aerosol generating system of FIG. 1, comprising the cleaning tool of FIG. 3 in the retracted state instead of the tobacco article of FIG. 2;

FIG. 6 is a perspective view of the aerosol generating system similar to the view of FIG. 5, wherein the cleaning tool is in the extended state;

FIG. 7 is a cross-sectional view of the aerosol generating system of FIG. 1, comprising the cleaning tool of FIG. 3 in the retracted state according to a variant of the first embodiment;

FIG. 8 is a cross-sectional view of the aerosol generating system similar to FIG. 7, wherein the cleaning tool of the variant of the first embodiment is in the extended state and received in a receiving cavity of the aerosol generating device;

FIG. 9 is a cross-sectional view of the aerosol generating system of FIG. 1, comprising a cleaning tool according to a second embodiment of the invention, and

FIG. 10 is a cross-sectional view of the aerosol generating system similar to FIG. 9, wherein the cleaning tool according to the second embodiment is received in the receiving cavity of the aerosol generating device.

### DETAILED DESCRIPTION OF THE INVENTION

Before describing the invention, it is to be understood that it is not limited to the details of construction set forth in the following description. It will be apparent to those skilled in the art having the benefit of the present disclosure that the invention is capable of other embodiments and of being practiced or being carried out in various ways.

The expression “substantially equal to” is understood hereinafter as an equality at plus or minus 10% and preferably at plus or minus 5%, and even more preferably at plus or minus 1%. According to some examples, this expression may designate exact equality.

As used herein, the term “aerosol generating device” or “device” may include a vaping device to deliver an aerosol to a user, including an aerosol for vaping, by means of a heater. The device may be portable. “Portable” may refer to the device being for use when held by a user. The device may be adapted to generate a variable amount of aerosol, e.g. by activating the heater for a variable amount of time (as opposed to a metered dose of aerosol), which can be controlled by a trigger. The trigger may be user activated, such as a vaping button and/or inhalation sensor. The inhalation sensor may be sensitive to the strength of inhalation as well as the duration of inhalation to enable a variable amount of vapour to be provided (so as to mimic the effect of smoking a conventional combustible smoking article such as a cigarette, cigar or pipe, etc.). The device may include a temperature regulation control to drive the temperature of the heater and/or the heated aerosol generating substance (aerosol pre-cursor) to a specified target temperature and thereafter to maintain the temperature at the target temperature that enables efficient generation of aerosol.

As used herein, the term “aerosol” may include a suspension of vaporizable material as one or more of: solid particles; liquid droplets; gas. Said suspension may be in a gas including air. Aerosol herein may generally refer to/include a vapour. Aerosol may include one or more components of the vaporizable material.

As used herein, the term “vaporizable material” or “precursor” may refer to a smokable material which may for example comprise nicotine or tobacco and an aerosol former. Tobacco may take the form of various materials such as shredded tobacco, granulated tobacco, tobacco leaf and/or reconstituted tobacco. Suitable aerosol formers include: a polyol such as sorbitol, glycerol, and glycols like propylene glycol or triethylene glycol; a non-polyol such as monohydric alcohols, acids such as lactic acid, glycerol derivatives, esters such as triacetin, triethylene glycol diacetate, triethyl citrate, glycerin or vegetable glycerin. In some embodiments, the aerosol generating agent may be glycerol, propylene glycol, or a mixture of glycerol and propylene glycol. The substrate may also comprise at least one of a gelling agent, a binding agent, a stabilizing agent, and a humectant.

### Description of a First Embodiment of the Invention

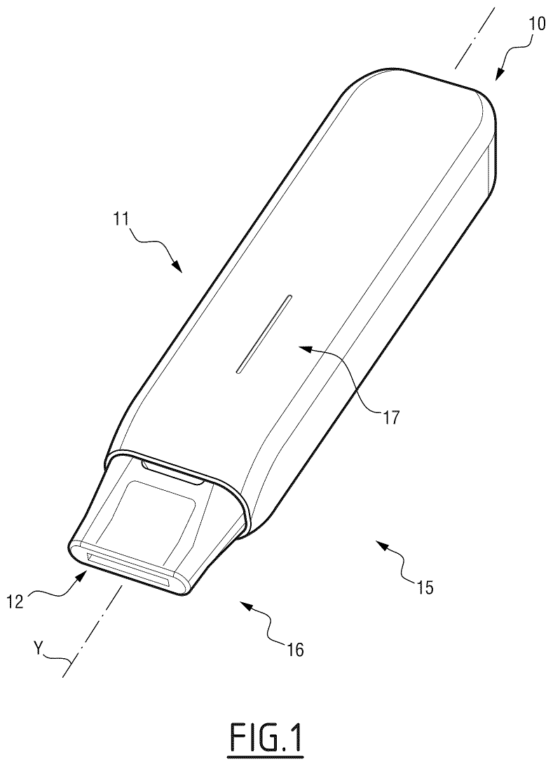

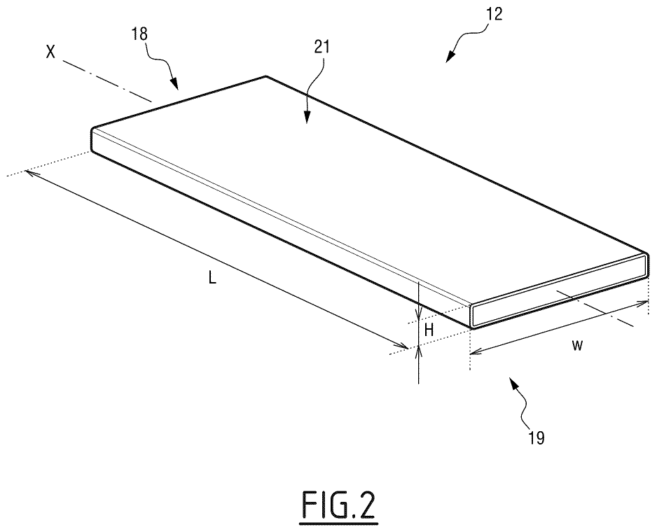

FIG. 1 shows an aerosol generating system 10 according to a first embodiment of the invention. The aerosol generating system 10 comprises an aerosol generating device 11, which is configured to receive a tobacco article 12. The aerosol generating device 11 is thus intended to operate with the tobacco article 12, which is shown in more detail in FIG. 2.

Referring to FIG. 1, the aerosol generating device 11 comprises a device body 15 extending along a device axis Y. The device body 15 comprises a mouthpiece 16 and a housing 17 arranged successively along the device axis Y. According to the example of FIG. 1, the mouthpiece 16 and the housing 17 form two different pieces. Particularly, according to this example, the mouthpiece 16 is designed to be fixed on or be received in an insertion opening 22 formed at one of the ends of the housing 17. In this case, the tobacco article 12 can be inserted inside the device 11 when the mouthpiece 16 is removed from the housing 17. According to another example (not-shown), the mouthpiece 16 and the housing 17 form one unique piece. In this case, the tobacco article 12 can be inserted inside the device 11 through for example a flow outlet. According to both examples, the mouthpiece 16 defines a through hole adapted to receive at least partially the tobacco article 12. Particularly, the through hole can be adapted to receive at least an outlet portion of the tobacco article 12, explained in further detail below. According to still another embodiment (not-shown), no mouthpiece 16 is provided with the aerosol generating device 11. In this case, the outlet portion of the tobacco article 12 can form a mouth end designed to be in contact with the user's lips and/or mouth while a vaping session.

The housing 17 delimits an internal space of the device 11 receiving various elements designed to carry out different functionalities of the device 11. The internal space may for example receive a battery for powering the device 11 and/or a controller (not-shown) for controlling the operation of the device 11.

The housing 17 further delimits a receiving cavity 20 of the device 11 configured to receive the tobacco article 12. In particular, the receiving cavity 20 defines the insertion opening 22 through which the tobacco article 12 may be inserted. The receiving cavity 20 may be for example arranged in the extension of the through hole of the mouthpiece 16, according to the device axis Y. The receiving cavity 20 is delimited by walls 23, 24 presenting for example a sensibly parallelepipedic shape, preferably complementary to the shape of the tobacco article 12 when the tobacco article 12 is flat-shaped for example.

By a receiving cavity 20 or a tobacco article 12 being “flat-shaped”, it is understood that the receiving cavity 20 (respectively the tobacco article 12) extends between two first parallel longitudinal planes and two second parallel longitudinal planes perpendicular to the first parallel longitudinal planes, the distance between the second parallel longitudinal planes being at least 3 times, advantageously 5 times and preferably 10 times, greater than the distance between the first parallel longitudinal planes.

The walls 23, 24 are advantageously at least partially made of ceramic. In particular, the receiving cavity 20 is delimited by lateral walls 23 extending in parallel to the device axis Y and by a bottom wall 24 extending perpendicularly to the device axis Y. For example, the receiving cavity 20 may be a cup-shaped chamber, which comprises preferably only the insertion opening 22.

The aerosol generating device 11 further comprises a heater 25 configured to heat the receiving cavity 20 and in particular the tobacco article 12 when being received in the receiving cavity 20. The heater 25 is in particular controlled by the controller of the device 11. The heater 25 may form at least a part of the lateral wall(s) 23.

The controller (not-shown) of the aerosol generating device 11 may be configured to control the heater 25 of the device 11 according to one or several heating profiles. For example, the controller may be configured for controlling the heater 25 according to a heating profile used to generate aerosol from the tobacco article 12 when the article 12 is inserted into the receiving cavity 20. The controller may be further configured for controlling the heater 25 according to a cleaning heating profile for using with a cleaning tool (described further in detail below), in particular when the cleaning tool is inserted into the receiving cavity 20. The cleaning heating profile may be different from the heating profile used to generate aerosol from the tobacco article 12.

With reference to FIG. 2, the tobacco article 12 is for example a flat-shaped cuboid extending along an article axis X between an inlet end 18 and an outlet end 19, and having external dimensions L×W×H. The tobacco article 12 is adapted to conduct an airflow from the inlet end 18 to the outlet end 19. In a typical example, the length L of the article 12 according to the article axis X equals substantially to 25-35 mm, for example 33 mm while its width W is comprised between 8 and 15 mm, for example substantially equal to 12 mm and height H is comprised between 0.8 and 2 mm, for example is substantially equal to 1.2 mm. According to different examples, the values L, W and H can be selected within a range of +/−40%, for example. In this typical example of external dimensions L×W×H, the tobacco article 12 is flat-shaped within the meaning of this application, since the width W is more than three times greater than the height H.

In the example of FIG. 2, the tobacco article 12 is wrapped by a single wrapper 21. In other words, in this example, the wrapper 21 is formed from a unique sheet wrapping substantially the whole length of the tobacco article 12 around the article axis X. In other examples, the wrapper 21 extends only along a part of the length of the tobacco article 12. For example, the wrapper 21 can extend only along a tobacco substrate of the tobacco article 12 and advantageously, wrap only the tobacco substrate, without covering for example a filter or a support structure of the tobacco article 12. According to another example, the wrapper 21 is formed from two different sheets wrapping separately for example the tobacco substrate and the filter or the support structure of the tobacco article 12. The wrapper 21 can be made of aluminium and/or paper. The paper can be coated with an impermeable coating to prevent liquid absorption like cooking/backing paper. In some embodiments, when the wrapper 21 is made of aluminium, it can wrap only the tobacco substrate to prevent condensation leakage and/or vapour leakage. Additionally, aluminium allows a better heat transfer.

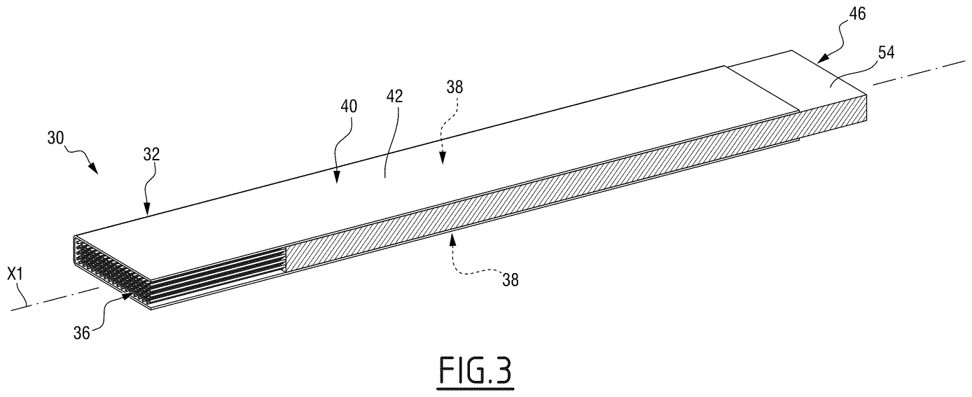

With reference to FIGS. 3 to 8, the aerosol generating system 10 comprises a cleaning tool 30 according to the first embodiment configured for cleaning the aerosol generating device 11. In particular, the cleaning tool 30 is configured to clean the receiving cavity 20 of the device 11. As it will be explained further below, by inserting the cleaning tool 30 through the insertion opening 22 in the receiving cavity 20 of the device 11, the cleaning tool 30 is able to detach dirt and/or humidity 31 attached to the walls 23, 24 of the receiving cavity 20.

The cleaning tool 30 extends along a tool axis X1 and comprises a cleaning portion 32 configured to be inserted in the receiving cavity 20. When the cleaning tool 30 is inserted in the receiving cavity 20, the tool axis X1 extends in particular parallel to the device axis Y, preferably is identical with the device axis Y.

The cleaning portion 32 may for example be flat-shaped. For example, the cleaning portion 32 may present a form substantially identical to the tobacco article 12 configured to be received in the receiving cavity 20. Preferably, the cleaning portion 32 may present a form that is complementary to a form or shape of the receiving cavity 20.

Hence, as well as for the receiving cavity 20, by a cleaning portion 32 being “flat-shaped”, it is understood that the cleaning portion 32 extends between two first parallel longitudinal planes and two second parallel longitudinal planes perpendicular to the first parallel longitudinal planes, the distance between the second parallel longitudinal planes being at least 3 times, advantageously 5 times and preferably 10 times, greater than the distance between the first parallel longitudinal planes

According to non-shown examples, the cleaning portion 32 may present a rounded cross-section according to a plan perpendicular to the tool axis X1, such as a circular cross-section. In this case, for example, a part of the cleaning portion 32 may be compressed by the walls 23, 24 of the receiving cavity 20 upon insertion into the receiving cavity 20.

The cleaning portion 32 may for example comprise a core 36 forming at least two opposite surfaces 38 and at least one layer 40 arranged adjacent to one of the opposite surfaces 38 of the core 36 and formed from a first absorptive material to absorb humidity 31 inside the receiving cavity 20. For example, the cleaning portion 32 comprises a sheath 42 comprising the first absorptive material. The sheath 42 may cover at least partially the core 36, and preferably cover the core 36 completely. In particular, the sheath 42 forms at least a part of the layer 40 arranged adjacent the opposite surface(s) 38.

The core 36 may comprise for example a second absorptive material able to absorb humidity 31. According to the first embodiment, the core 36 may comprise a plurality of fibers 44. In particular, the fibers 44 may be oriented according to the tool axis X1.

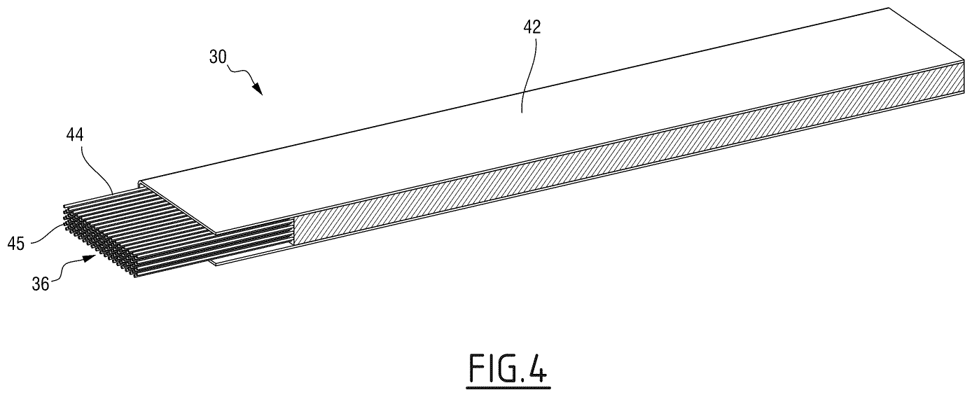

The cleaning tool 30 may be mobile between a retracted state, visible in particular in FIGS. 3, 5 and 7, and an extended state, visible in particular in FIGS. 4, 6 and 8. In particular, the core 36 may be moveable relative to the sheath 42 so as to change the state from the retracted state to the extended state. In particular, the core 36 may be designed to slide relative to the sheath 42. The retracted state may in particular protect fibers 44 of the core 36 during insertion of the cleaning tool 30 into the receiving cavity 20. In the extended state, a part of the core 36, in particular the fibers 44, may extend from a distal end of the sheath 42 so as to absorb humidity 31 in the receiving cavity 20. For example, ends 45 of the fibers be in contact with the bottom wall 24 in the extended state.

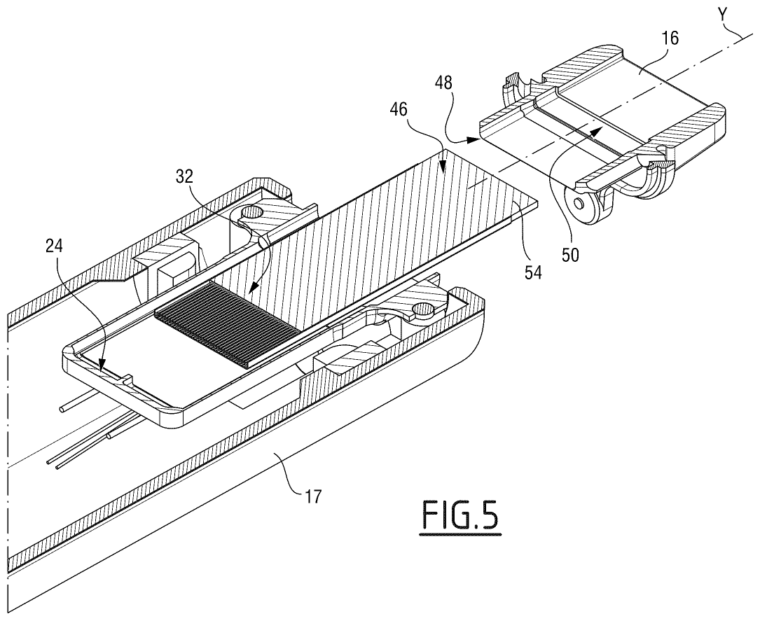

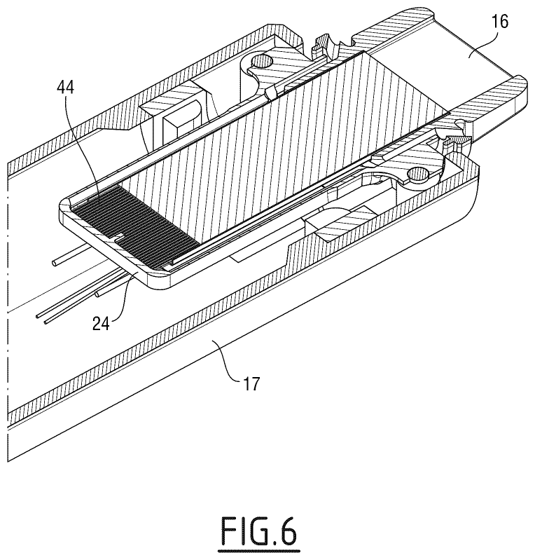

The cleaning tool 30 may further comprise a gripping portion 46 arranged successively with the cleaning portion 32 and designed to be outside the receiving cavity 20 when the cleaning portion 32 is inserted in the receiving cavity 20. According to the examples of FIGS. 5 and 6, the gripping portion 46 is designed to be inserted into a central hole 48 of the mouthpiece 16, in particular along a direction of an airflow in the mouthpiece 16 when a user takes a puff during operation of the aerosol generating device 11 with the tobacco article 12. For example, the gripping portion 46 is designed to enter in contact with a stopper flange 50 of the mouthpiece 16, visible in particular in FIG. 5, upon insertion into the central hole 48 of the mouthpiece 16. The stopper flange 50 allows in particular pushing, via the gripping portion 46, the cleaning portion 32 towards the bottom wall 24 of the receiving cavity 20 when the cleaning tool 30 is inserted into the receiving cavity 20 and the mouthpiece 16 is placed on the insertion opening 22.

For example, the gripping portion 46 may comprise a plunger 54 movable according to the tool axis X1. The fibers 44 may be mounted on the plunger 54. Preferably, the plunger 54 may be movable in respect with the sheath 42 and according to the tool axis X1. Thus, in particular, upon activation of the plunger 54, the cleaning tool 30 may change from the retracted state to the extended state or vice-versa. For example, upon activating the plunger 54, the fibers 44 are configured to extend from a distal end of the cleaning tool 30, and are arranged to face the bottom wall 24 of the receiving cavity 20 when the cleaning tool 30 is inserted into the receiving cavity 20.

According to examples, in particular if the sheath 42 covers at least an end of the core 36 along the tool axis X1, the fibers 44 may be configured to pierce the sheath 42 upon activation of the plunger 54.

Preferably, the first and/or second absorptive material is chosen in the group comprising cotton; absorbent paper such as blotting paper; super absorbent fiber; porous material such porous polymeric fiber or porous composite and functionalized or bioactivated porous media.

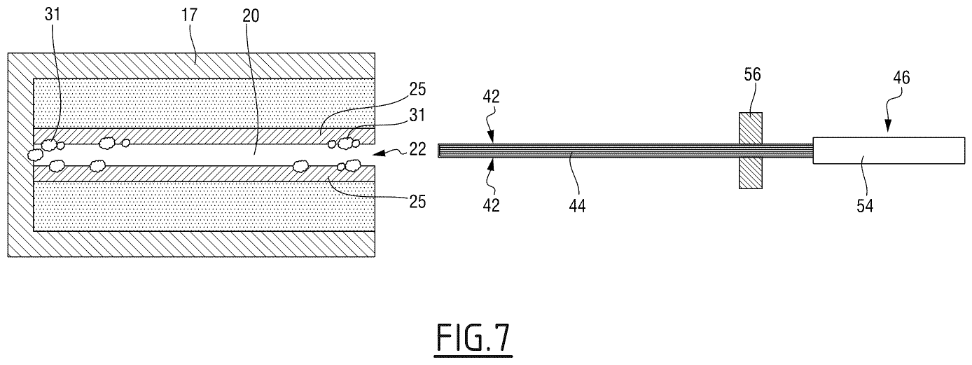

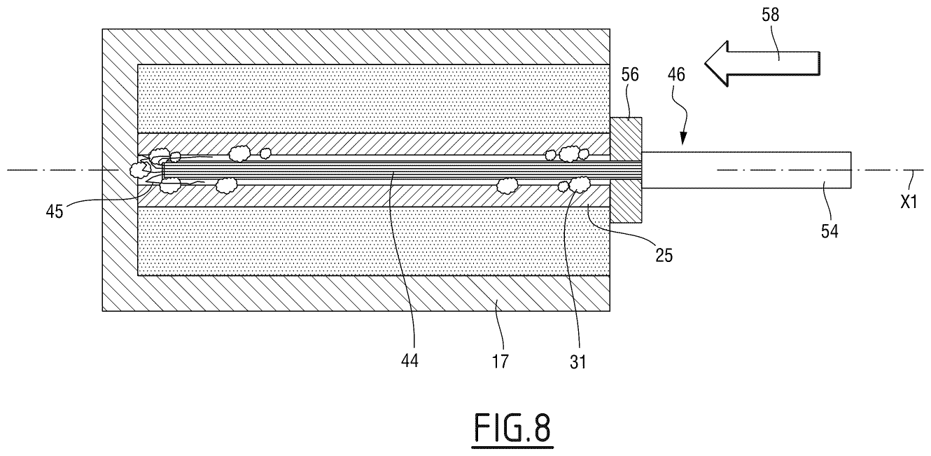

According to examples, as illustrated in particular in FIGS. 7 and 8, the cleaning tool may further comprise a stopper 56. The stopper 56 may be fixed to the sheath 42. Furthermore, the stopper 56 may be designed to enter in contact with an edge of the insertion opening 22 when the cleaning portion 32 is inserted into the receiving cavity 20. Upon contact of the stopper 56 with the edge, the plunger 54 with the fibers 44 fixed to it is designed to be pushed further along the tool axis X1 towards the bottom wall 24 of the receiving cavity 20. This is illustrated for example in FIG. 8 by arrow 58. Due to the movement of the plunger 54 with the fibers 44 relative to the sheath 42, the fibers 44 may extend from the distal end of the cleaning tool 30 facing the bottom wall 24 of the receiving cavity 20. In particular, the ends 45 enter in contact with the bottom wall 24.

### Description of a Second Embodiment of the Invention

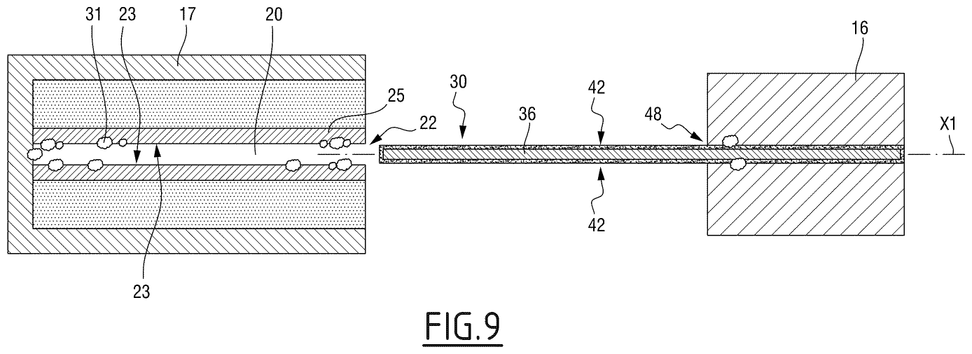

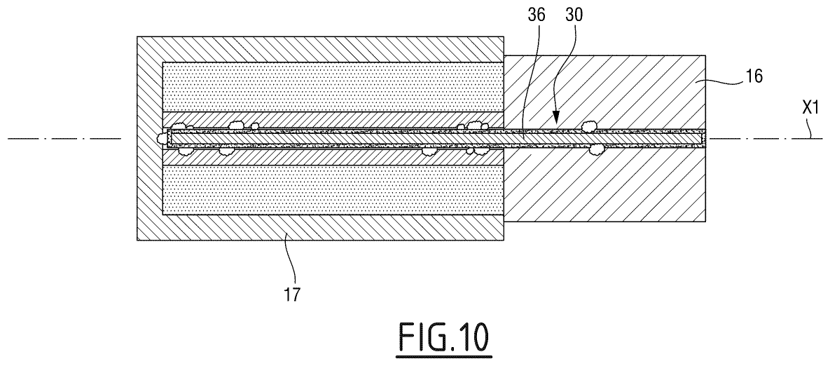

With reference to FIGS. 9 and 10, an aerosol generating system 10 according to a second embodiment of the invention is now described. The aerosol generating system 10 according to the second embodiment comprises at least some features of the first embodiment. The same or corresponding elements are designated by the same reference signs. Only the differences are described hereafter.

The core 36 of the cleaning tool 30 according to the second embodiment may form a rigid structure. In particular, the core 36 may present a material different from the material of the layer 40 arranged adjacent to the opposite surface(s) 38 of the core 36. For example, the core 36 may be devoid of fibers 44. According to some examples, only the sheath 42 may comprise or consist of absorptive material, such as the first absorptive material. By “rigid structure”, it may be understood in particular that the structure presents a rigidity or stiffness against deformation strictly higher than a rigidity or stiffness of fibers or material from at least one, or any one, of the following materials: cotton; absorbent paper such as blotting paper; super absorbent fiber; porous material such porous polymeric fiber or porous composite; functionalized or bioactivated porous media.

According to some examples, the sheath 42 may completely cover the core 36, including for example ends of the core 36 along the tool axis X1. For example, the sheath 42 may be attached to the core 36. In particular, the core 36 may be unable to move relative to the sheath 42 surrounding the core 36.

For example, the cleaning tool 30 according to the second embodiment may consist of the cleaning portion 32, i.e. may be devoid of a gripping portion. One end of the cleaning portion 32 along the tool axis X1 may be designed to be inserted into the central hole 48 of the mouthpiece 16, for example as illustrated in FIG. 9. The opposite end of the cleaning portion 32 along the tool axis X1 may be designed to be inserted into the receiving cavity 20, for example as illustrated in FIG. 10.

### Other Embodiments

According to other embodiments, features of the first and second embodiment may be combined. For example, the core 36 of the second embodiment may be combined with any of the features of the cleaning tool 30 of the first embodiment.

1. A cleaning tool for cleaning an aerosol generating device having a receiving cavity,
the cleaning tool extending along a tool axis and comprising a flat-shaped cleaning portion comprising:
a core defining at least two opposite surfaces;
at least one layer arranged adjacent to one of the opposite surfaces of the core and comprising a first absorptive material configured to absorb humidity.

2. The cleaning tool according to claim 1, wherein the cleaning portion comprises a sheath comprising said first absorptive material, the sheath covering at least partially the core.

3. The cleaning tool according to claim 1, wherein the core is a rigid structure.

4. The cleaning tool according to claim 1, wherein the core comprises a second absorptive material configured to absorb humidity.

5. The cleaning tool according to claim 1, wherein the core comprises a plurality of fibers.

6. The cleaning tool according to claim 5, wherein the plurality of fibers are oriented according to the tool axis.

7. The cleaning tool according to claim 6, wherein:
the cleaning portion comprises a sheath; and
the plurality of fibers are mounted on a plunger movable according to the tool axis with respect to the sheath.

8. The cleaning tool according to claim 7, wherein upon activating the plunger, the plurality of fibers are configured to extend from a distal end of the cleaning tool.

9. The cleaning tool according to claim 8, wherein upon activating the plunger, the plurality of fibers are configured to pierce the sheath.

10. The cleaning tool according to claim 1, further comprising a gripping portion arranged successively with the cleaning portion.

11. The cleaning tool according to claim 10, wherein the gripping portion comprises a plunger movable according to the tool axis.

12. The cleaning tool according to claim 1, wherein the first absorptive material is at least one of:
cotton;
absorbent paper;
super absorbent fiber;
porous material; or
functionalized or bioactivated porous media.

13. An aerosol generating system comprising:
an aerosol generating device comprising a receiving cavity configured to receive a tobacco article and a heater configured to heat the receiving cavity; and
the cleaning tool according to claim 1, the cleaning portion of said cleaning tool being configured to be inserted in the receiving cavity of said aerosol generating device.

14. The aerosol generating system according to claim 13, wherein the aerosol generating device comprises a controller configured to control the heater according to a cleaning heating profile for using with the cleaning tool, the cleaning heating profile being different from a heating profile used to generate aerosol from a tobacco article.

15. The aerosol generating system according to claim 13, wherein the cleaning tool further comprises a gripping portion arranged successively with the cleaning portion and configured to be outside the receiving cavity when the cleaning portion is inserted in the receiving cavity.

16. The aerosol generating system according to claim 15, wherein the gripping portion is configured to be inserted into a central hole of a mouthpiece of the aerosol generating device.

17. The aerosol generating system according to claim 13, wherein the cleaning tool further comprises a plunger arranged successively with the cleaning portion, movable according to the tool axis, and designed to be outside the receiving cavity when the cleaning portion is inserted in the receiving cavity.

18. The cleaning tool according to claim 1, further comprising a plunger arranged successively with the cleaning portion and movable according to the tool axis.

19. The cleaning tool according to claim 4, wherein the second absorptive material is at least one of:
cotton;
absorbent paper;
super absorbent fiber;
porous material; or
functionalized or bioactivated porous media.
